(19) United States
(12) Patent Application Publication
(10) Pub. No.: US 2015/0294246 A1
(43) Pub. Date: Oct. 15, 2015

(54) SELECTING OPTIMAL TRAINING DATA SET FOR SERVICE CONTRACT PREDICTION

(71) Applicant: International Business Machines Corporation, Armonk, NY (US)

(72) Inventors: Sinem Guven Kaya, New York, NY (US); Tsuyoshi Ide, Harrison, NY (US); Sergey Makogon, Sandy, UT (US); Amitkumar M. Paradkar, Mohegan Lake, NY (US); Mathias B. Steiner, Rio de Janeiro (BR); Alejandro Venegas Middleton, Santiago (CL)

(21) Appl. No.: 14/472,568

(22) Filed: Aug. 29, 2014

Related U.S. Application Data
(60) Provisional application No. 61/978,131, filed on Apr. 10, 2014.

(51) Int. Cl. G06Q 10/06

(52) U.S. Cl. CPC G06Q 10/067; G06Q 10/0635; G06Q 10/06393

(57) ABSTRACT

A selection parameter is applied to a set of risk assessment data and corresponding performance measure data for a completed, or active, project that is similar to a proposed project. Certain combinations of the risk assessment data and corresponding performance measure data are selected for training an optimal predictive model. The predictive model is applied to available data of a proposed project for predicting associated risks, or outcomes, of the proposed project.

### FIELD OF THE INVENTION

The present invention relates generally to the field of data processing, and more particularly to predictive models.

### BACKGROUND OF THE INVENTION

A key performance indicator (KPI) is a type of performance measurement. An organization may use KPIs to evaluate its success, or to evaluate the success of a particular activity in which it is engaged. Sometimes success is defined in terms of making progress toward strategic goals, but often success is simply the repeated, periodic achievement of some level of operational goal (such as zero defects, 10/10 customer satisfaction, etc.). Various techniques to assess the present state of the business, and its key activities, are associated with the selection of performance indicators. These assessments often lead to the identification of potential improvements, so performance indicators are routinely associated with ‘performance improvement’ initiatives. A very common way to choose KPIs is to apply a management framework such as the balanced scorecard.

The growing trend of big data enables organizations to drive innovation through advanced predictive analytics that provide new and faster insights into their customers' needs. For example, according to some sources, by 2016, seventy percent of the most profitable companies will manage their businesses using real-time predictive analytics. In fact, IT service providers are already relying more and more on predictive analytics for advanced risk management. Such analytics enable service providers to predict risks ahead of time and proactively manage them to eliminate or minimize their impact.

Proactive management of service contract risks ahead of contract signing is becoming increasingly important for IT service providers due to the cost pressure associated with IT outsourcing. Within an end-to-end risk management process, various risk assessments are performed at multiple stages before a service contract is signed. Based on the risk assessment data, service providers seek to have predictive models that indicate risks of future service contracts.

Within the service delivery domain, one of the main applications of analytics is to predict one or more KPIs in the engagement phase in order to reveal contractual issues as early as possible. When building a risk model for predicting contract performance, even if we focus on a specific risk assessment as input and a specific KPI as a target, there is still a wide range of inputs and targets to choose from with variable time delays in between, given that risk assessments and KPI measurements are performed several times across the service contract lifecycle.

The term contract risk assessment (CRA) refers to the service contract risk assessment surveys. CRAs are executed at discrete time points (such as once a year, on demand, etc.). The CRA provides a temporary view of assessed risks until the performance of the next CRA. The term contract performance measure (CPM) includes a single KPI, or several KPIs merged together through business logic, to track contract performance. As described above, CRA data and CPM data are collected across different stages of the contract lifecycle at varying frequencies and time intervals depending on the complexity of the contract.

### SUMMARY

In one aspect of the present invention, a method, a computer program product, and a system includes: determining a data sub-set selection parameter for a first data set, selecting a plurality of data sub-sets from the first data set based, at least in part, on the data sub-set selection parameter, training a plurality of predictive models with corresponding data sub-sets of the plurality of data sub-sets, determining an accuracy level of a predictive model of the plurality of predictive models, and selecting a preferred predictive model based, at least in part, on a corresponding accuracy level. The corresponding data sub-sets include a risk-assessment portion of the first data set and a performance-measure portion of the first data set.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a diagram showing a first event timeline according to an embodiment of the present invention; and

FIG. 5 is a diagram showing a second event timeline according to an embodiment of the present invention.

### DETAILED DESCRIPTION

A selection parameter is applied to a set of risk assessment data and performance measure data for a completed, or active, project that is similar to a proposed project. Certain combinations of the risk assessment data and corresponding performance measure data are selected for training a predictive model. The predictive model is applied to available data of a proposed project for predicting associated risks, or outcomes, of the proposed project. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

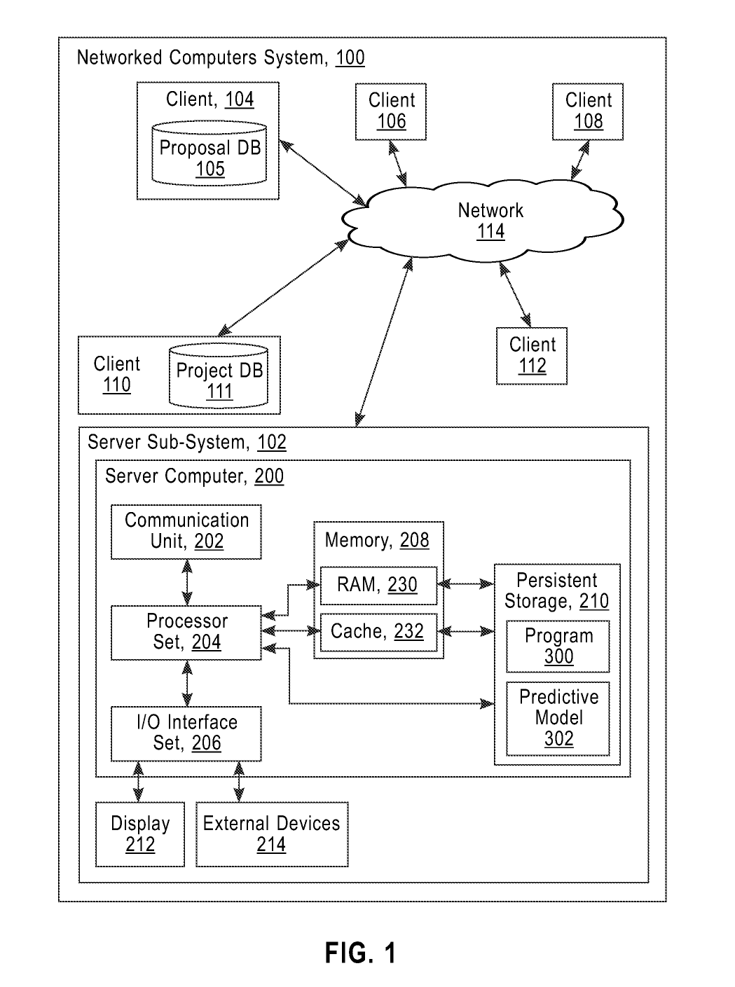

The present invention will now be described in detail with reference to the Figures. FIG. 1 is a functional block diagram illustrating various portions of networked computers system 100, in accordance with one embodiment of the present invention, including: server sub-system 102; client sub-systems 104, 106, 108, 110, 112; proposal database 105; project database 111; communication network 114; server computer 200; communication unit 202; processor set 204; input/output (I/O) interface set 206; memory device 208; persistent storage device 210; display device 212; external device set 214; random access memory (RAM) devices 230; cache memory device 232; program 300; and predictive model 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Some embodiments of the present invention operate to select an appropriate project data set representation of a completed project, such as a software development project, in terms of its risk assessment data and performance measurement data. The project data set is used to train a predictive model to predict whether a planned, or proposed, project will be successful. During a software development project, there may be several assessments related to risks. Also, there may be several performance tests including: (i) tests before the product release; and (ii) tests throughout actual usage of the product. In that way, project performance outcomes are recorded. These assessments and tests generate project data set information.

Key performance indicators (KPIs) define a set of values used to measure performance against. These raw sets of values, which are fed to systems in charge of summarizing the information, are called indicators. Indicators, identifiable and marked as possible candidates for KPIs, can be summarized into the following sub-categories: (i) quantitative indicators that can be presented with a number; (ii) qualitative indicators that can't be presented as a number; (iii) leading indicators that can predict the outcome of a process; (iv) lagging indicators that present the success or failure post hoc; (v) input indicators that measure the amount of resources consumed during the generation of the outcome; (vi) process indicators that represent the efficiency or the productivity of the process; (vii) output indicators that reflect the outcome or results of the process activities; (viii) practical indicators that interface with existing company processes; (ix) directional indicators specifying whether or not an organization is getting better; (x) actionable indicators that are sufficiently in an organization's control to effect change; and/or (xi) financial indicators used in performance measurement and when looking at an operating index. Key performance indicators, in practical terms and for strategic development, are objectives to be targeted that will add the most value to the business. IT-related examples of KPIs include: (i) availability/uptime; (ii) mean time between failures; (iii) mean time to repair; (iv) unplanned unavailability; (v) whether timely delivery occurs; (vi) whether meeting/exceeding financial goals; and (vii) client satisfaction.

Where a proposed software development project is similar (in terms of the project features and risks) to a completed or deployed project, a user will benefit by using the deployed project data set to predict whether the proposed project will be successful in terms of a particular performance metric (for example, no crashes). To train the predictive model, an understanding of which assessment/performance data pairs (referred to herein as project data sets) best represents the deployed project. A project data set is selected according to some embodiments of the present invention, such that a preferred pairing of data is determined.

A service contract lifecycle includes four phases: (i) engagement phase; (ii) transition and transformation phase; (iii) steady state phase; and (iv) contract completion or renegotiation phase. In this discussion, the transition and transformation phase and the steady state phase are discussed as a single, combined phase, referred to herein as the service delivery phase. Predictive analytics can help in the engagement (or pre-contract) phase to make informed decisions about whether to sign a risky contract, as well as how much contingency should be included in the contract price. In the transition and transformation phase, where the IT service provider transforms the client's infrastructure and operations into a format that they can effectively manage, predictive analytics can provide insights into operational risks based on historical data to help proactively mitigate those risks. In steady state phase, where the outsourcing service reaches maturity, but there is less tolerance for failure, predictive analytics can be used to detect and prevent system failures. Accordingly, predictive analytics is integrated into various steps within the end-to-end risk management process.

Throughout the service contract lifecycle, risk management insights are typically collected through surveying risk managers or quality assurance experts. Such risk assessment data, which mainly comprises ranked score values, is a valuable source for predictive analytics as it already captures the status quo of the contract at hand. For service contracts, risk assessment surveys are typically conducted at variable time intervals depending on the complexity of the project. The more complex the project is, the earlier the risk management is involved, and the more often the risk assessments are conducted. There may be several different types of risk assessment surveys, some of which include but are not limited to: (i) technical assessment; (ii) client assessment; and (iii) solution assessment. Throughout the lifecycle of a service contract, several risk managers and independent quality assurance experts perform these surveys to ensure that input is collected from all perspectives. In that way, the same survey is repeated several times across different time ranges.

During the service delivery phase, which contains both the transition and transformation and the steady state phases, service providers track the performance of outsourcing contracts through different key performance indicators. Similar to the risk assessment surveys, KPIs are collected at variable time intervals depending on the complexity and the health of the contract. The more troubled the contract is, the more attention it will need and the more often the KPIs will be measured and updated.

Program 300 operates to create project data sub-set(s) from a historic project according to one, or more, selection parameters. The data sub-set(s) are used to train a predictive model to predict project risks for projects having similar performance metrics. Additionally, program 300 may test multiple project data sub-sets using the predictive model to predict risks that are known for the historical project. In that way, a preferred data sub-set is identified for use in predicting risks of similar proposed projects.

Some embodiments of the present invention recognize the following facts, potential problems, and/or potential areas for improvement with respect to the current state of the art: (i) considering the wide range of risk assessments, the variable frequency in which they are conducted, their sequential nature, and the prevalent data scale, naïve statistical modeling approaches, such as linear regression, are not readily applicable to such data sets; (ii) it is unclear which data selection criteria should be applied to narrow down the scope, or how data selection affects prediction accuracy; (iii) the sequential nature of the survey data precludes the assumption of statistical independence between observations; (iv) the ordinal scale level of survey data means that statistical models that require interval or ratio scale levels are not suitable; (v) it is often difficult to straightforwardly interpret the meaning of individual regression coefficients; (vi) most naïve modeling techniques do not perform well on data sets with blank entries; and/or (vii) it is difficult for risk models based on naïve modeling techniques to automatically re-train or evolve with the changing data sets.

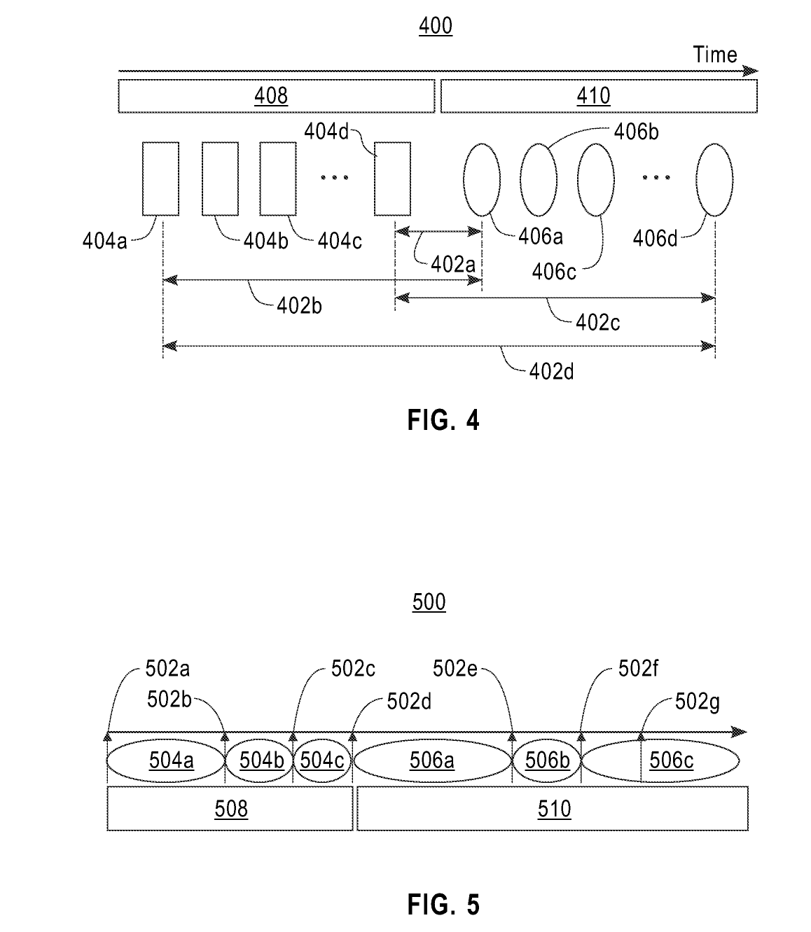

Other use-cases discussed herein are service contracts, manufacturing processes, and natural resource management. Service contract management is discussed in detail below with respect to FIGS. 4 and 5.

Some embodiments of the present invention may be used to select an appropriate representation of a completed manufacturing project, such as automobile manufacturing, in terms of its risk assessments and performance measurements. The appropriate representation may be used to train a predictive model to predict whether a similar proposed project will be successful. During automobile manufacturing, there may be several assessments performed during the manufacturing process to understand one, or more, risks. Also, there may be several performance tests performed, including: (i) tests before delivery of the automobile; and (ii) tests throughout actual usage of the automobile. In that way, project performance outcomes are recorded. Where a proposed automobile manufacturing project is similar (in terms of project features and risks) to a complete manufacturing project, a user will benefit by using the completed project as a reference model to predict whether the proposed project will be successful in terms of a particular performance metric (for example, no engine problems). To train the predictive model, an understanding of which assessment/performance data pairs best represents the completed manufacturing project. An optimal data set may be selected according to some embodiments of the present invention, that is, an optimal pairing may be determined. The term “optimal” as used herein refers to a selected or otherwise chosen data set or pairing of data set portions. The basis for making the selection of the data set or data set portions is discussed at length in this detailed description.

Also, some embodiments of the present invention may be used to optimize drilling and/or mining conditions in natural resources management. In such a case, the risk assessment data represents recovery-related risks (such as operational and/or environmental risks). Further, the performance data represents key performance indicators (such as resource recovery rates and/or return on investment). These key performance indicators are typically monitored on a continuous basis.

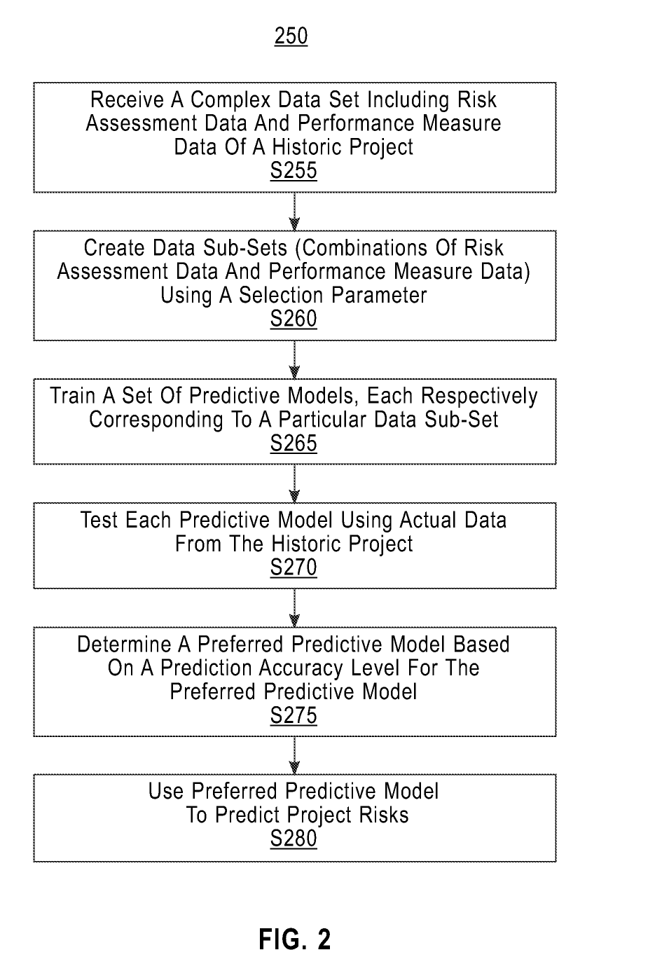

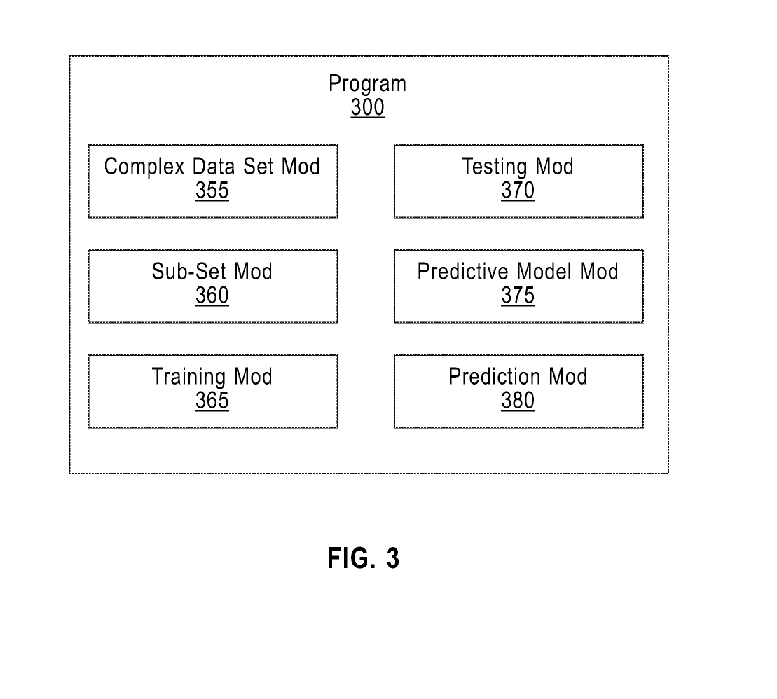

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where complex data set module 355 receives a complex data set, also referred to as a project data set, for a historic project. The complex data set includes risk assessment data and performance measure data for the historic project. The historic project may be one that has been completed or one that is deployed and has reached steady state performance. In this example, the complex data set is received from project database 111 in client sub-system 110 (FIG. 1).

Processing proceeds to step S260, where sub-set module 360 creates project data sub-sets (combinations of risk assessment data and performance measure data) using a selection parameter. Selection parameters include: (i) time delay (e.g. chronological); (ii) quality; (iii) duration; (iv) location; (v) operator; and/or (vi) quantity. Each project data sub-set may be made up of risk assessment data for one parameter value and the performance measure data from another parameter value. For example, the risk assessment data may represent that of Operator Able and the performance data may represent that of Operator Baker.

Processing proceeds to step S265, where training module 365 trains a set of predictive models, each model respectively corresponding to a particular data sub-set. The particular data sub-set is selected from among the project data sub-sets created in step S260. For each model, a particular data sub-set is used for training purposes. In that way, the prediction(s) from each model are based on a unique data sub-set from the complex data set received in step S255.

Processing proceeds to step S270, where testing module 370 tests each predictive model using the actual data from the particular historic project. The predictive models produce risk predictions based on the limited training from the particular data sub-sets used during training. It is expected that the risk predictions will vary from predictive model to predictive model.

Processing proceeds to step S275, where predictive model module 375 determines a preferred predictive model according to a prediction accuracy level for the predictive model. Accuracy metrics include: (i) directional accuracy; (ii) non-profitable contract prediction accuracy (NPCP); and/or (iii) profitable contract prediction accuracy (PCP). Directional accuracy refers to how accurately the predictive model predicts whether an opportunity will become profitable. NPCP refers to how accurately the predictive model predicts the opportunities that will become non-profitable. PCP refers to how accurately the predictive model predicts the opportunities that will become profitable. Although the objective of the predictive models is to achieve a high classification accuracy for non-profitable projects, the accuracy of the profitability prediction is just as important. Without a high PCP accuracy, false negative predictions may lead to unnecessary risk mitigation activities in healthy projects.

Processing ends at step S280, where prediction module 380 uses the preferred predictive model determined in step S275, to predict project risks for projects similar to the historic project. The predictive model is used the predict risk for a proposed project based on proposal data 105 in client sub-system 104 (FIG. 1). A detailed discussion is provide below with respect to predicting project risks in light of limitations in risk assessment and performance measure data.

Further embodiments of the present invention are discussed in the paragraphs that follow and later with reference to FIGS. 4 and 5. The discussion that follows is drafted with reference to the use case of service contract management.

Within the service delivery domain, one of the main applications of analytics is to predict one or more of such KPIs in the engagement phase in order to reveal contractual issues as early as possible. When building a risk model for predicting contract performance, even if we focus on a specific risk assessment as input and a specific KPI as a target, there is still a wide range of inputs and targets to choose from with variable time delays in between. It is, however, unclear which data selection criteria should be applied to narrow down the scope, or how data selection affects prediction accuracy. Another important issue with the IT outsourcing data is that, due to its complicating characteristics (described in more detail below), naïve statistical modeling approaches, such as linear regression, are not readily applicable. In the following paragraphs, the characteristics and the complexity of the IT contract risk data is discussed.

FIG. 4 is a diagram showing service contract management timeline 400 including: time distributions 402a, 402b, 402c, and 402d, contract risk assessments (CRA) 404a, 404b, 404c, and 404d; contract performance measures (CPM) 406a, 406b, 406c, and 406d; service engagement phase 408; and service delivery phase 410.

CRA data, such as 404a, is generated through surveys, which vary, for example, from 20-200 questions. Each survey question typically has a variety of categorical answers to choose from, which range from high to low, or vice versa. For each such survey, there is an underlying algorithm, which calculates a final risk assessment score based on question answers. CPM data, such as 406a, can be in the form of a survey (in which case an underlying algorithm calculates a CPM score) or an actual measurement (such as the gross profit of the contract for that month). As mentioned earlier, each CPM data set may represent one, or several, KPIs.

Some embodiments of the present invention analyze time delays, such as 402b, between risk assessments and contract performance measurements (e.g. KPIs), to understand how the training data set selection affects the accuracy of contract risk predictions. The analysis of this data provides insight as to how to improve the accuracy of prediction models through optimization of the data selection process. While much of the discussion that follows addresses managing the risk of IT outsourcing contracts (or service contracts), it should be understood by persons skilled in the art that the methodology applies equally to other domains with similar data characteristics.

As mentioned above, complicating data characteristics are an important issue with IT outsourcing data. Complicating data characteristics include: (i) variable time delay; (ii) incomplete data; and/or (iii) evolving data. Variable time delay is a characteristic of a set of CRA and CPM data that refers to the fact that the set of data may not necessarily come from periodic assessments, but rather from varying time frames (as they are conducted on an as-needed basis). This means that there is a variable time delay between CRA and CPM data rendering some data points potentially irrelevant due to major time lag. Incomplete data is a characteristic of the set of CRA and CPM data in that this set of data may contain “blanks” as not all assessment questions and/or performance measures are mandatory. Evolving data is a characteristic of a set of CRA and CPM data in that the needs of the business and the corresponding risks change over time, requiring changes in the risk assessment questions and/or performance measures. For CRA data, this results in surveys having modified and/or new questions. For CPM data, the definition of the performance measures may change and/or new measures may be added. The unique combination of data characteristics described above render predictive modeling for IT outsourcing a non-trivial task.

In the following discussion, the focus is on understanding financial profitability of a service contract by predicting the gross profit variance KPI denoted by K(ΔGP). This numeric KPI is defined as the projected gross profit minus the actual gross profit. The first step to building a predictive model is to perform training for data selection from our historical data set. Where only one type of CRA is the input, and the K(ΔGP) is the target, a wide range of input and target variables are available to choose from because CRAs and KPIs are measured several times across the service contract lifecycle. To better illustrate the complexity of the data selection problem, a use case having hundreds of historical contracts will be considered. Each of the historical contracts have several iterations of the selected CRA, and, similarly, several measurements of the selected target KPI, K(ΔGP). This means that, for each historical contract, the training data should include the one CRA and the one K(ΔGP) that best represents that historical contract's risks, and observed gross profit variance, respectively. Populating the training data set with the right CRA and K(ΔGP) instances for hundreds of historical contracts is a significant endeavor.

Some embodiments of the present invention use the k-nearest neighbor (KNN) approach to predict K(ΔGP) in light of the recognized limitations of IT outsourcing data. Unlike many modeling techniques, such as linear regression, KNN does not rely on a specific parametric model. Instead, it simply uses k-value historical contracts that are most similar to the new opportunity to predict the K(ΔGP) for that new opportunity. Because each prediction is represented by the most similar historical contracts, KNN allows highly interpretable results. Also, due to the nonparametric nature of KNN, it can handle complex, nonlinear relationships between the input and the target variables. Further, KNN has the flexibility to be tailored to business requirements through customizable notions of similarity.

Some embodiments of the present invention use correlation between input and target variables as weights when calculating contract similarity. The input and target variables are indicators of the importance of CRA questions in determining a contract's K(ΔGP).

Some embodiments of the present invention provide a predictive model that is fully parameterized to enable identification of various optimal thresholds that maximize the model's performance, including: (i) question-importance threshold is used to ensure that only the most relevant CRA questions are ultimately used in determining contract similarity; (ii) contract-similarity threshold is used to determine the minimum degree of similarity a historical contract should have to the new opportunity before it can be included in the K(ΔGP) prediction; and (iii) outliers-parameter is a Boolean that determines whether outliers beyond a defined observed K(ΔGP) range should be included or excluded from the calculations, considering the vast range of observed K(ΔGP)s in historical data.

Once contracts similar to the new opportunity are identified, a weighted average of their observed K(ΔGP)s is determined by considering the degree of similarity to determine the final K(ΔGP) prediction for the new opportunity, as shown in the following equation:

K(ΔGP)=Σ^{(ΔGPActual}^{ᵢ}^{*ContractSimilarity}^{ᵢ}⁾/TotalSimilarity

where: K(ΔGP) is the gross profit variance KPI; ΔGPActual is the actual gross profit variance for a similar contract; ContractSimilarity is the similarity of the similar contract to a new opportunity; TotalSimilarity is the aggregated sum of the similarities of all similar contracts to the new opportunity.

Some embodiments of the present invention select a training data set through a data-driven methodology based on machine learning techniques. One example of an optimal data selection methodology entails the following steps: (i) determine if a selection parameter, such as time delay, has any significance in selecting training data, given the wide range of input and target variables with varying time frames (for example, if a given historical contract has the same CRA repeated several times, understand if using the first one vs. the last one has any effect on the accuracy of models trained with such CRAs); (ii) if the selection parameter does have significance, select the optimal selection parameter in the data set, for example time window, where the selection parameter is time delay, (once the optimal data set is selected, train the predictive model using this data set to maximize prediction accuracy).

Some embodiments of the present invention provide a method for optimal, or preferred, data parameter selection to maximize prediction accuracy that includes: (i) choose a parameter for data set selection (such as, time delay: first vs. last, quality: best vs. worst); (ii) determine if selected parameter has any significance in selecting training data (for example, if a given historical contract has the same CRA repeated several times, understand if using the first one vs. the last one has any effect on the accuracy of models trained with such CRAs); (iii) create all data combinations; (iv) train with a predictive model; (v) test with the predictive model; (vi) if selected parameter, such as time delay, does have significance, select the optimal data set combination, such as optimal time window, in the data set; and (vii) train the predictive model using the optimal data set combination to maximize prediction accuracy.

At a high level, the problem of selecting a preferred data set resembles the well-known research areas of feature selection and sample selection. Feature selection refers to algorithms that select a sub-set of the input data features that performs best under a certain classification system. Some embodiments of the present invention select the optimal time window (based on the entire available data set) by monitoring and maximizing the prediction accuracy of the risk models, irrespective of the number of features.

Sample selection, on the other hand, is focused on how to achieve a good accuracy for a predictive model with a reasonable number of sample points. The accuracy of a predictive model is, to a large extent, determined by the modeling technique used, but the sample selection often has a direct influence on the model performance. Some embodiments of the present invention do not optimize the number of sample points, but determine a preferred time distribution of the modeling data set to achieve maximum prediction accuracy in the resulting risk models, independent of the modeling algorithm used.

Some embodiments of the present invention prepare input data using the following data clean-up criteria: (i) exclude incomplete CRAs and CPMs: we do not perform any data filling so as not to introduce any bias to the data; (ii) exclude unique survey questions (that are not part of all CRAs or CPMs—if they are in the form of a survey to avoid performing any question mapping so as not to introduce any bias to the data; (iii) exclude temporal inconsistencies, for example, calculating the time difference between CRAs and CPMs and excluding those CRA-CPM combinations with a negative time delay, indicating CPM data obtained before the CRA data.

Based on the above criteria, and the selection parameter of time delay, four data sets are selected that represent different time delays 402a, 402b, 402c, and 402d between CRAs and CPMs. Because risk assessment results and service contract status are subject to change over time, it is reasonable to assume that the accuracy of predictive models trained on the data will critically depend on the time delay between them. Nevertheless, other data selection criteria, such as the risk assessment outcome or the performance measurement result, e.g. best-case versus worst-case, may also be considered.

The data set characterized by time delay 402a connects for each service contract, the last risk assessment performed in service engagement phase 408, in this example, 404d, with the first performance measure conducted in service delivery phase 410, in this example, 406a. Similarly, the data set characterized by time delay 402b connects the first risk assessment, 404a, with the first performance measure, 406a, while time delay 402c represents the data set that associates the last risk assessment, 404d, with the last performance measure, 406d. Finally, time delay 402d characterizes the data set that correlates the first risk assessment, 404a, with the last performance measure, 406d.

FIG. 5 is a diagram showing service contract management timeline 500 including: (i) start time 502a; 3-month before contract signature time 502b; 1-month before contract signature time 502c; contract signature time 502d; 18-month after contract signature time 502e; 24-month after contract signature time 502f; 36-month after contract signature time 502g; contract risk assessment (CRA) periods 504a, 504b, 504c; contract performance measure (CPM) periods 506a, 506b, 506c; service engagement phase 508; and service delivery phase 510.

Time window selection for CRA periods and CPM periods, as applied here, reflects specifics of the data set of this example and constitutes a convenient choice in the present case. In principle, the above approach can be applied with arbitrary time windows, for example, in order to provide a higher temporal resolution. Also, the data set could be segmented based on other parameters that characterize the data set. Furthermore, by considering computing resources required for processing large data sets or statistical significance requirements for smaller data sets, it can be reasonable to use and combine different data selection methods. In the following paragraphs, the temporal resolution of the data set selection is further improved by means of statistical testing.

Some embodiments of the present invention provide a method for selecting a time window within the data set with an increased temporal granularity. Specifically, based on business rules, three time windows, or periods, from each of two phases, engagement phase 508 and service delivery phase 510. One process that applies such a strategy includes the following steps with reference to FIG. 5: (i) generate training samples by taking a combination of two time windows, one from the engagement phase and one from the service delivery phase (in this example, the process yields nine time window combinations (TWC); that is, there are three engagement periods 504a, 504b, 504c and three performance measure periods 506a, 506b, 506c); (ii) determine a preferred data set combination, or TWC, such as 504a and 506b, by evaluating the informativeness of each TWC (in this example, the informativeness is evaluated by using statistical two-sample tests; that is, for each of the training data sets belonging to the nine TWCs, the historical contracts are separated into two groups according to the directionality (positive or negative) of their gross profit variance); (iii) evaluate the difference between probability distributions of the historical contracts' CRA questions (to quantitatively measure the distributional distance, the single-variable Kolmogorov-Smirnov (KS) statistics are averaged over the CRA questions, the bigger the averaged KS statistic, the more informative the TWC); and (iv) if there is no significant difference between the positive and negative gross profit variance groups, the selected TWC is determined to be not informative. Exemplary predictive model data is provided in Tables 1 and 2, below. Table 1 presents the accuracy of a predictive model based on an initial data set. Table 2 presents the accuracy of a predictive model based on the preferred, or selected, data set 504b and 506c.

TABLE 1
Accuracy of predictive model based on initial data set.

| METRIC | DIRECTIONAL | NPCP | PCP |
|---|---|---|---|
| ACCURACY | 59% | 71% | 52% |

TABLE 2
Different run-time scenarios tested with optimally trained
(504b and 506c) model.

| RUN- | | | | ENGAGEMENT | DELIVERY |
|---|---|---|---|---|---|
| TIME | DIREC- | | | TRAINING | TRAINING |
| WINDOW | TIONAL | NPCP | PCP | DATA | DATA |
| 504c | 71% | 72% | 70% | 504b | 506c |
| 504b | 76% | 86% | 68% | 504b | 506c |
| 504a | 74% | 81% | 68% | 504b | 506c |

Aside from determining a preferred time window, another important consideration for the data set is the low correlation between the input and target variables. Some embodiments of the present invention use the correlation coefficients as weights to determine the relatively more important CRA questions. Some embodiments of the present invention ensure that only the relevant CRA questions are included in contract similarity calculations.

Some embodiments of the present invention use the KS statistics calculated for selecting the preferred window for variable weights. Because the KS statistic is a measure of informativeness to predict the directionality, and because it is automatically normalized within the range of 0 to 1 by definition, the KS statistic may be used as the variable weight. If the weight is 1 for a CRA question, the question is viewed as decisive when indicating directionality. If the weight is 0, there is no difference in the distributions between positive and negative gross profit variance groups.

An improvement in prediction accuracy when using KS statistics in this way is due to two changes: (i) reference data selection is improved; and (ii) the CRA question importance weighting is improved. An important consideration with this result is whether the model accuracy generalizes to other run-time windows given that the model is trained using only the preferred data set, for example, 504b and 506c. Testing, as shown in Table 2, indicates that accuracies obtained for preferred data run-time window 504b do not necessarily generalize to all run-time windows. While 504a accuracies are very similar to optimal 504b, the NPCP accuracy for 504c falls to 72%, well below the optimal 86% of 504b.

Some embodiments of the present invention address this issue by splitting the predictive model configuration into two settings: (i) preferred configuration (training data and thresholds) to train the predictive model to be used in 504b and 504c run-times; and (ii) determine a new set of training data and thresholds that are preferred for 504a run-time. Selecting and applying multiple configurations in real-time is a trivial matter due to the automated training capability of the KNN-based model, discussed above.

Depending on the business goals for a given project, a user may select a different result (and thus a different set of threshold values) that will maximize NPCP, PCP, and/or directional metrics. For example, if the business goal is to maximize NPCP for a given run-time window, a threshold configuration having an 86% NPCP accuracy, at the expense of a 58% PCP accuracy, may be selected.

Some embodiments of the present invention develop a predictive model consisting of two different parts, each of which is trained with its respective data set and optimal thresholds. In practice, when the risk managers or the quality assurance experts perform a CRA and want to use the CRA data to predict a contract's financial performance, the predictive model trains itself automatically in real-time using the preferred data set and the preferred parameters of its run-time window. Such flexibility allows a user to maintain optimal accuracy for a given predictive model as the training data set is updated with new historical contracts over time.

A methodology is provided for building a financial performance prediction model with enhanced accuracy using ordinal risk assessment (survey score) data as model input. The identification of relevant data selection criteria, such as the time delay between risk assessment and performance measurement, is one way to improve prediction accuracy in data-driven, predictive risk modeling. Such improved predictive models enable proactive risk management and lead to cost reduction and improved quality in IT service delivery.

Some embodiments of the present invention define, for a finished outsourcing contract data set, a suitable data set selection parameter, such as time delay. Some embodiments of the present invention construct a plurality of data set combinations (from finished service contracts) that represent different choices of the parameter (such as time delay=3 months and time delay=6 months). Further, some embodiments use these data set combinations to train and test predictive models, while maintaining machine-learning algorithms and modeling conditions constant. Still further, some embodiments use the training and testing results to analyze the classification (prediction) accuracy attained with the different data set combinations. Still further, some embodiments choose a preferred data set combination that provides the highest classification accuracy for the predictive model according to the results of the training and testing.

Some embodiments of the present invention may include one, or more, of the following features, characteristics and/or advantages: (i) predict service contract risks based on ordinal risk assessment data; (ii) enables optimal risk prediction for service contracts within an enterprise-level risk management ecosystem; (iii) provides guidance to data scientists and researchers both in the service delivery domain as well as other domains with similar data characteristics; (iv) builds optimal predictive models from complex IT outsourcing data sets; (v) predict KPIs reliably using CRA data at engagement time; (vi) predicts one, or more, KPIs at engagement time; (vii) applies strategy for optimal data selection to maximize prediction accuracy; and/or (viii) uses data mining and machine learning approaches to ensure selection of preferred model parameters, thereby improving the accuracy of risk prediction models.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
determining a target data sub-set selection parameter for a first data set;
selecting a plurality of data sub-sets from the first data set based, at least in part, on the target data sub-set selection parameter;
training a plurality of predictive models with corresponding data sub-sets of the plurality of data sub-sets;
determining an accuracy level of a predictive model of the plurality of predictive models; and
selecting a preferred predictive model based, at least in part, on a corresponding accuracy level;
wherein:
the corresponding data sub-sets include a risk-assessment portion of the first data set and a performance-measure portion of the first data set.

2. The method of claim 1, further comprising;
predicting project risk for a first project according to operation of the preferred predictive model;
wherein:
the first data set contains risk assessment data and performance measure data for a second project that is completed.

3. The method of claim 1, wherein the target data sub-set selection parameter is one of the following: time delay from a contract signature time, quality, duration, location, operator, and quantity.

4. The method of claim 1, wherein the first data set contains risk assessment data and performance measure data for a first service contract.

5. The method of claim 1, wherein the step of determining a target data sub-set selection parameter includes:
identifying a first selection parameter;
recording a first value of the first selection parameter in the first data set for a first predictive model to produce a first result;
recording a second value of the first selection parameter in the first data set for the first predictive model to produce a second result; and
responsive to the first result being different than the second result, identifying the first selection parameter as a target data sub-set selection parameter.

6. A computer program product comprising a computer readable storage medium having stored thereon:
first program instructions programmed to determine a target data sub-set selection parameter for a first data set;
second program instructions programmed to select a plurality of data sub-sets from the first data set based, at least in part, on the target data sub-set selection parameter;
third program instructions programmed to train a plurality of predictive models with corresponding data sub-sets of the plurality of data sub-sets;
fourth program instructions programmed to determine an accuracy level of a predictive model of the plurality of predictive models; and
fifth program instructions programmed to select a preferred predictive model based, at least in part, on a corresponding accuracy level;
wherein:
the corresponding data sub-sets include a risk-assessment portion of the first data set and a performance-measure portion of the first data set.

7. The computer program product of claim 6, further comprising;
sixth program instructions programmed to predict project risk for a first project according to operation of the preferred predictive model;
wherein:
the first data set contains risk assessment data and performance measure data for a second project that is completed.

8. The computer program product of claim 6, wherein the target data sub-set selection parameter is one of the following: time delay from a contract signature time, quality, duration, location, operator, and quantity.

9. The computer program product of claim 6, wherein the first data set contains risk assessment data and performance measure data for a first service contract.

10. The computer program product of claim 6, wherein the first program instructions to determine a target data sub-set selection parameter include:
program instructions to identify a first selection parameter;
program instructions to record a first value of the first selection parameter in the first data set for a first predictive model to produce a first result;
program instructions to record a second value of the first selection parameter in the first data set for the first predictive model to produce a second result; and
program instructions to, responsive to the first result being different than the second result, identify the first selection parameter as a target data sub-set selection parameter.

11. A computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to determine a target data sub-set selection parameter for a first data set;
second program instructions programmed to select a plurality of data sub-sets from the first data set based, at least in part, on the target data sub-set selection parameter;
third program instructions programmed to train a plurality of predictive models with corresponding data sub-sets of the plurality of data sub-sets;
fourth program instructions programmed to determine an accuracy level of a predictive model of the plurality of predictive models; and
fifth program instructions programmed to select a preferred predictive model based, at least in part, on a corresponding accuracy level;
wherein:
the corresponding data sub-sets include a risk-assessment portion of the first data set and a performance-measure portion of the first data set.

12. The computer system of claim 11, further comprising;
sixth program instructions programmed to predict project risk for a first project according to operation of the preferred predictive model;
wherein:
the first data set contains risk assessment data and performance measure data for a second project that is completed.

13. The computer system of claim 11, wherein the target data sub-set selection parameter is one of the following: time delay from a contract signature time, quality, duration, location, operator, and quantity.

14. The computer system of claim 11, wherein the first data set contains risk assessment data and performance measure data for a first service contract.

15. The computer system of claim 11, wherein the first program instructions to determine a target data sub-set selection parameter include:
program instructions to identify a first selection parameter;
program instructions to record a first value of the first selection parameter in the first data set for a first predictive model to produce a first result;
program instructions to record a second value of the first selection parameter in the first data set for the first predictive model to produce a second result; and
program instructions to, responsive to the first result being different than the second result, identify the first selection parameter as a target data sub-set selection parameter.
